(19) United States
(12) Patent Application Publication
(10) Pub. No.: US 2025/0140900 A1
(43) Pub. Date: May 1, 2025

(54) ELECTROLYTE MEMBRANES FOR BATTERIES THAT CYCLE LITHIUM IONS AND METHODS OF MANUFACTURING THE SAME

(71) Applicant: GM GLOBAL TECHNOLOGY OPERATIONS LLC, Detroit, MI (US)

(72) Inventors: Xin ZHANG, Shanghai (CN); Zhe LI, Shanghai (CN); Qili SU, Shanghai (CN); Thomas A. YERSAK, Royal Oak, MI (US); Haijing LIU, Shanghai (CN)

(21) Appl. No.: 18/521,081

(22) Filed: Nov. 28, 2023

(30) Foreign Application Priority Data
Oct. 25, 2023 (CN) 202311394072.4

(51) Int. Cl. H01M 10/056; H01M 10/052

(52) U.S. Cl. CPC H01M 10/056; H01M 10/052; H01M 2300/0065

(57) ABSTRACT

An electrolyte membrane for a battery that cycles lithium ions includes a sulfide-based solid electrolyte, a polymer binder, an inorganic filler, an inorganic lithium salt, and an ionic liquid. The sulfide-based solid electrolyte includes lithium sulfide (Li₂S) and at least one element selected from the group consisting of phosphorus (P), tin (Sn), silicon (Si), germanium (Ge), boron (B), gallium (Ga), and aluminum (Al). The ionic liquid includes substantially equimolar amounts of a cation and an anion. The cation includes a complex of lithium (Li⁺) and an ethylene glycol dimethyl ether, an imidazolium ion, a piperidinium ion, a pyrrolidinium ion, an ammonium ion, a phosphonium ion, or a combination thereof. The anion includes an arsenate ion, a phosphate ion, a sulfonylimide ion, a borate ion, a chlorate ion, or a combination thereof.

### CROSS-REFERENCE TO RELATED APPLICATIONS

This application claims the benefit of Chinese Patent Application No. 202311394072.4, filed on Oct. 25, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to electrolyte membranes comprising a sulfide-based solid electrolyte and an ionic liquid.

Batteries that cycle lithium ions generally comprise a negative electrode, a positive electrode, and an electrolyte that provides a medium for the conduction of lithium ions between the negative and positive electrodes. Sulfide-based solid electrolytes are promising candidates due to their ability to establish intimate interfacial contact with electrode materials, and their excellent ionic conductivity at room temperature.

### SUMMARY

An electrolyte membrane for a battery that cycles lithium ions is disclosed. The electrolyte membrane comprises a sulfide-based solid electrolyte, a polymer binder, an inorganic filler, an inorganic lithium salt, and an ionic liquid. The sulfide-based solid electrolyte comprises lithium sulfide (Li₂S) and at least one element selected from the group consisting of phosphorus (P), tin (Sn), silicon (Si), germanium (Ge), boron (B), gallium (Ga), and aluminum (Al). The ionic liquid comprises substantially equimolar amounts of a cation and an anion. The cation comprises a complex of lithium (Li⁺) and an ethylene glycol dimethyl ether, an imidazolium ion, a piperidinium ion, a pyrrolidinium ion, an ammonium ion, a phosphonium ion, or a combination thereof. The anion comprises an arsenate ion, a phosphate ion, a sulfonylimide ion, a borate ion, a chlorate ion, or a combination thereof.

The cation in the ionic liquid may comprise a complex of lithium (Li⁺) and triethylene glycol dimethyl ether; a complex of lithium (Li⁺) and tetraethylene glycol dimethyl ether; 1-ethyl-3-methylimidazolium; 1-propyl-3-methylimidazolium; 1-butyl-3-methylimidazolium; 1,2-dimethyl-3-butylimidazolium; 1-alkyl-3-methylimidazolium, 1-allyl-3-methylimidazolium; 1,3-diallylimidazolium; 1-allyl-3-vinylimidazolium; 1-vinyl-3-ethylimidazolium; 1-cyanomethyl-3-methylimidazolium; 1,3-dicyanomethyl-imidazolium; 1-propyl-1-methylpiperidinium; 1-butyl-1-methylpiperidinium; 1-methyl-1-ethylpyrrolidinium; 1-propyl-1-methylpyrrolidinium; 1-butyl-1-methylpyrrolidinium; methyl-methylcarboxymethyl-pyrrolidinium; tetramethylammonium; tetraethylammonium; tributylmethylammonium; diallyldimethylammonium; N—N-diethyl-N-methyl-N-(2-methoxyethyl)ammonium; N,N-diethyl-N-(2-methacryloylethyl)-N-methylammonium; trimethylisobutyl-phosphonium; triisobutylmethylphosphonium; tributylmethylphosphonium; diethylmethylisobutyl-phosphonium; trihexdecylphosphonium; trihexyltetradecylphosphonium; or a combination thereof.

The anion in the ionic liquid may comprise hexafluoroarsenate, hexafluorophosphate, bis(fluorosulfonyl)imide, bis(trifluoromethanesulfonyl)imide, perchlorate, tetrafluoroborate, cyclo-difluoromethane-1,1-bis(sulfonyl)imide, bis(perfluoroethanesulfonyl)imide, bis(oxalato)borate, difluorooxalatoborate, bis(fluoromalonato)borate, or a combination thereof.

The ionic liquid may further comprise a diluent selected from the group consisting of dimethyl carbonate, ethylene carbonate, ethyl acetate, acetone, acetonitrile, toluene, propylene carbonate, diethyl carbonate, 1,1,2,2-tetrafluoroethyl-2,2,3,3-tetrafluoropropyl ether, and combinations thereof.

The sulfide-based solid electrolyte may comprise lithium sulfide (Li₂S) and at least one additional inorganic compound selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), arsenic sulfide (As₂S₅), and manganese sulfide (MnS).

The sulfide-based solid electrolyte may comprise a binary sulfide comprising lithium sulfide (Li₂S) and at least one additional sulfide selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), and aluminum sulfide (Al₂S₃).

The sulfide-based solid electrolyte may comprise a ternary sulfide comprising lithium sulfide (Li₂S) and at least two additional inorganic compounds selected from the group consisting of phosphorus sulfide (P₂S₅), tin sulfide (SnS₂), silicon sulfide (SiS₂), germanium sulfide (GeS₂), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), and arsenic sulfide (As₂S₅).

The sulfide-based solid electrolyte may comprise a quaternary sulfide comprising lithium sulfide (Li₂S) and at least three additional inorganic compounds selected from the group consisting of phosphorus sulfide (P₂S₅), tin sulfide (SnS₂), silicon sulfide (SiS₂), lithium oxide (Li₂O), phosphorus oxide (P₂O₅), lithium chloride (LiCl), lithium iodide (LiI), and manganese sulfide (MnS).

The polymer binder may comprise polyethylene oxide (PEO), polyvinylidene difluoride (PVDF), nitrile butadiene rubber (NBR), hydrogenated acrylonitrile butadiene rubber (HNBR), styrene butadiene rubber (SBR), polystyrene-block-poly(ethylene-ran-butylene)-block-polystyrene (SEBS), or a combination thereof.

The inorganic filler may comprise aluminum oxide (Al₂O₃), silicon dioxide (SiO₂), or a combination thereof.

The inorganic lithium salt may comprise lithium bis(trifluoromethanesulfonyl)imide (LiN(CF₃SO₂)₂), lithium hexafluorophosphate (LiPF₆), lithium bis(fluorosulfonyl)imide (LiN(FSO₂)₂) (LiFSI), or a combination thereof.

In aspects, the sulfide-based solid electrolyte may comprise lithium phosphorus sulfur chloride (Li₆PS₅Cl), the polymer binder may comprise polyethylene oxide, the inorganic filler comprises aluminum oxide, the inorganic lithium salt may comprise lithium bis(fluorosulfonyl)imide, and the ionic liquid may comprise substantially equimolar amounts of (i) a complex of lithium (Li⁺) and tetraethylene glycol dimethyl ether and (ii) bis(trifluoromethanesulfonyl)imide.

The electrolyte membrane may have a thickness of greater than or equal to about 5 micrometers and less than or equal to about 500 micrometers.

A battery that cycles lithium ions is disclosed. The battery comprises a negative electrode comprising an electroactive negative electrode material, a positive electrode spaced apart from the negative electrode and comprising an electroactive positive electrode material, and an electrolyte membrane disposed between the negative electrode and the positive electrode that provides a medium for the conduction of lithium ions between the negative electrode and the positive electrode. The electrolyte membrane comprises a sulfide-based solid electrolyte, a polymer binder, an inorganic filler, an inorganic lithium salt, and an ionic liquid. The sulfide-based solid electrolyte comprises lithium sulfide (Li₂S) and at least one element selected from the group consisting of phosphorus (P), tin (Sn), silicon (Si), germanium (Ge), boron (B), gallium (Ga), and aluminum (Al). The ionic liquid comprises substantially equimolar amounts of a cation and an anion. The cation comprises a complex of lithium (Li⁺) and an ethylene glycol dimethyl ether, an imidazolium ion, a piperidinium ion, a pyrrolidinium ion, an ammonium ion, a phosphonium ion, or a combination thereof. The anion comprises an arsenate ion, a phosphate ion, a sulfonylimide ion, a borate ion, a chlorate ion, or a combination thereof.

The ionic liquid may comprise a complex of lithium (Li⁺) and triethylene glycol dimethyl ether; a complex of lithium (Li⁺) and tetraethylene glycol dimethyl ether; 1-ethyl-3-methylimidazolium; 1-propyl-3-methylimidazolium; 1-butyl-3-methylimidazolium; 1,2-dimethyl-3-butylimidazolium; 1-alkyl-3-methylimidazolium, 1-allyl-3-methylimidazolium; 1,3-diallylimidazolium; 1-allyl-3-vinylimidazolium; 1-vinyl-3-ethylimidazolium; 1-cyanomethyl-3-methylimidazolium; 1,3-dicyanomethyl-imidazolium; 1-propyl-1-methylpiperidinium; 1-butyl-1-methylpiperidinium; 1-methyl-1-ethylpyrrolidinium; 1-propyl-1-methylpyrrolidinium; 1-butyl-1-methylpyrrolidinium; methyl-methylcarboxymethyl-pyrrolidinium; tetramethylammonium; tetraethylammonium; tributylmethylammonium; diallyldimethylammonium; N—N-diethyl-N-methyl-N-(2-methoxyethyl)ammonium; N,N-diethyl-N-(2-methacryloylethyl)-N-methylammonium; trimethylisobutyl-phosphonium; triisobutylmethylphosphonium; tributylmethylphosphonium; diethylmethylisobutyl-phosphonium; trihexdecylphosphonium; trihexyltetradecylphosphonium; or a combination thereof.

The anion in the ionic liquid may comprise hexafluoroarsenate, hexafluorophosphate, bis(fluorosulfonyl)imide, bis(trifluoromethanesulfonyl)imide, perchlorate, tetrafluoroborate, cyclo-difluoromethane-1,1-bis(sulfonyl)imide, bis(perfluoroethanesulfonyl)imide, bis(oxalato)borate, difluorooxalatoborate, bis(fluoromalonato)borate, or a combination thereof.

The sulfide-based solid electrolyte may comprise lithium sulfide (Li₂S) and at least one additional inorganic compound selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), arsenic sulfide (As₂S₅), and manganese sulfide (MnS).

The polymer binder may comprise polyethylene oxide (PEO), polyvinylidene difluoride (PVDF), nitrile butadiene rubber (NBR), hydrogenated acrylonitrile butadiene rubber (HNBR), styrene butadiene rubber (SBR), polystyrene-block-poly(ethylene-ran-butylene)-block-polystyrene (SEBS), or a combination thereof.

The inorganic filler may comprise aluminum oxide (Al₂O₃), silicon dioxide (SiO₂), or a combination thereof.

The inorganic lithium salt may comprise lithium bis(trifluoromethanesulfonyl)imide (LiN(CF₃SO₂)₂), lithium hexafluorophosphate (LiPF₆), lithium bis(fluorosulfonyl)imide (LiN(FSO₂)₂) (LiFSI), or a combination thereof.

A method of manufacturing an electrolyte membrane for a battery that cycles lithium ions is disclosed. In the method, a precursor mixture is prepared and deposited on a substrate to form a precursor layer. The precursor mixture comprises a sulfide-based solid electrolyte, a polymer binder, an inorganic filler, an inorganic lithium salt, an ionic liquid, and a solvent. The sulfide-based solid electrolyte comprises lithium sulfide (Li₂S) and at least one element selected from the group consisting of phosphorus (P), tin (Sn), silicon (Si), germanium (Ge), boron (B), gallium (Ga), and aluminum (Al). The ionic liquid comprises substantially equimolar amounts of a cation and an anion. The cation comprises a complex of lithium (Li⁺) and an ethylene glycol dimethyl ether, an imidazolium ion, a piperidinium ion, a pyrrolidinium ion, an ammonium ion, a phosphonium ion, or a combination thereof. The anion comprises an arsenate ion, a phosphate ion, a sulfonylimide ion, a borate ion, a chlorate ion, or a combination thereof. After the precursor mixture is deposited on the substrate to form the precursor layer, the solvent is removed from the precursor layer to form the electrolyte membrane.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, and an electrolyte membrane disposed between the positive electrode and the negative electrode.

FIG. 4 is a detailed view of the electrolyte membrane of FIG. 3.

In the drawings, reference numbers may be reused to identify similar and/or identical elements.

### DETAILED DESCRIPTION

The presently disclosed electrolyte membranes are formulated for use in batteries that cycle lithium ions and comprise a sulfide-based solid electrolyte, a polymer binder, an inorganic filler, an inorganic lithium salt, and an ionic liquid. Inclusion of the ionic liquid in the electrolyte membrane increases the ionic conductivity of the electrolyte membrane, without altering the chemical composition or crystal structure of the sulfide-based solid electrolyte.

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

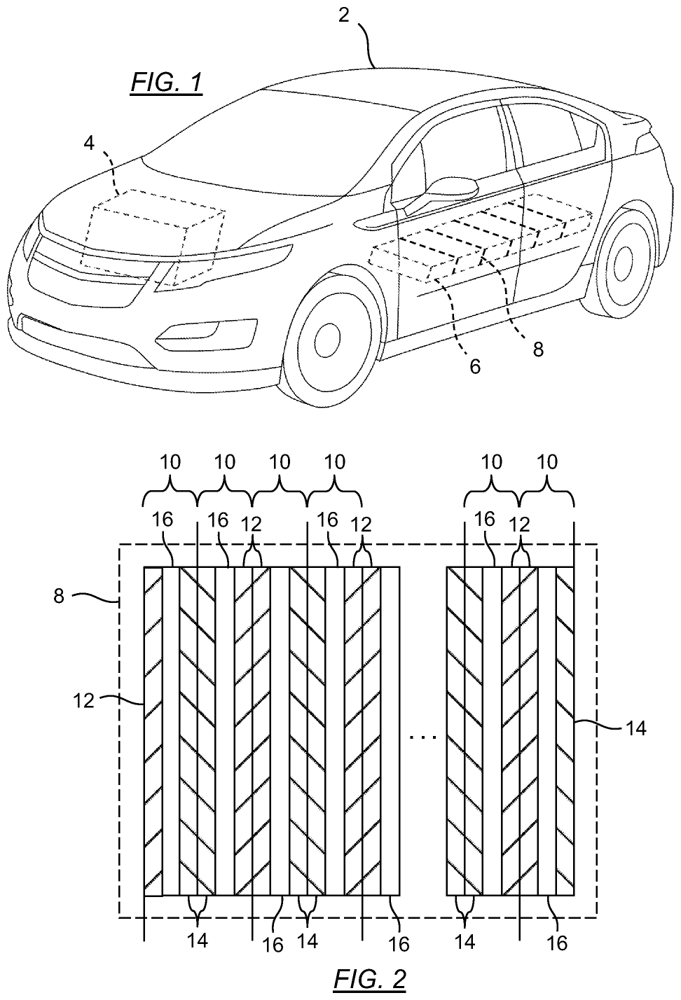

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

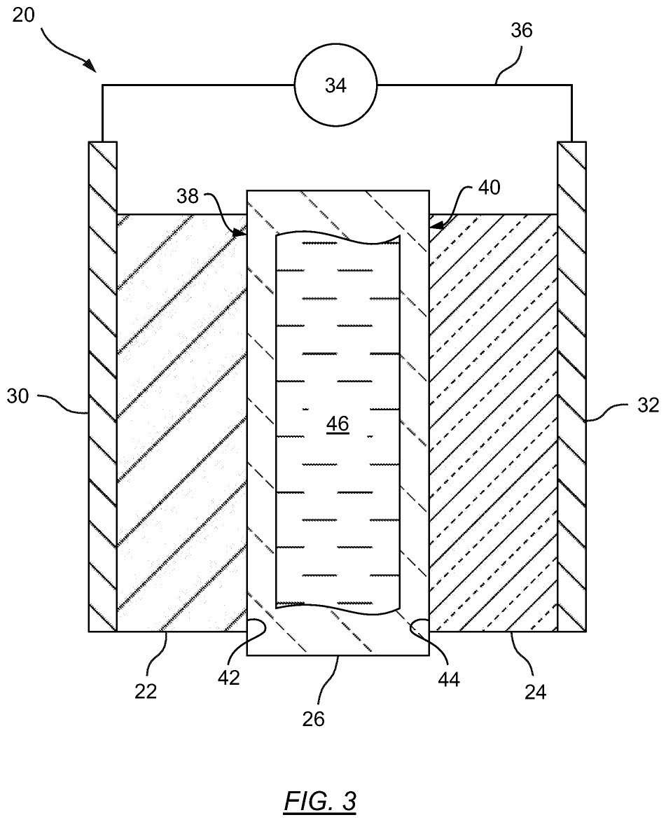

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, and an electrolyte membrane 26 sandwiched between the negative electrode 22 and the positive electrode 24 and having a first side 38 and an opposite second side 40. The negative electrode 22 and the positive electrode 24 have opposing facing surfaces 42, 44, with the facing surface 42 of the negative electrode 22 being in physical contact with the first side 38 of the electrolyte membrane 26 and the facing surface 44 of the positive electrode 24 being in physical contact with the second side 40 of the electrolyte membrane 26. The negative electrode 22 is disposed on a negative electrode current collector 30 and the positive electrode 24 is disposed on a positive electrode current collector 32.

In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte membrane 26, while the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

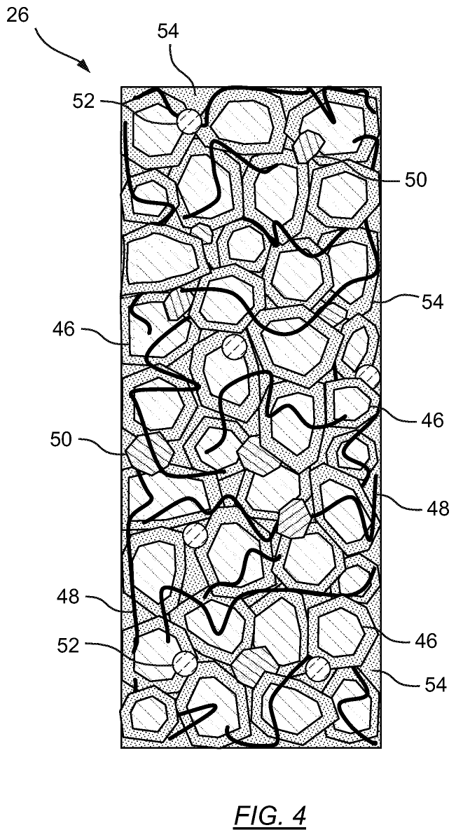

The electrolyte membrane 26 extends between the negative electrode 22 and the positive electrode 24, from the facing surface 42 of the negative electrode 22 to the facing surface 44 of the positive electrode 24. The electrolyte membrane 26 may have a thickness of greater than or equal to about 5 micrometers (μm), or optionally greater than or equal to about 20 μm and less than or equal to about 500 μm, or optionally less than or equal to about 200 μm. The electrolyte membrane 26 is ionically conductive and provides a medium for the conduction of lithium ions through the battery 20 between the negative electrode 22 and the positive electrode 24. In embodiments, the electrolyte membrane 26 may function as a separator and may physically separate and electrically isolate the negative electrode 22 and the positive electrode 24 from each other while permitting lithium ions to pass therethrough. The electrolyte membrane 26 may have an ionic conductivity at room temperature (e.g., about 25° C.) of greater than or equal to about 0.1 millisiemens per centimeter (mS/cm), optionally greater than or equal to about 0.2 mS/cm, or optionally greater than or equal to about 0.5 mS/cm and less than or equal to about 20 mS/cm. For example, in aspects, the electrolyte membrane 26 may have an ionic conductivity at room temperature of greater than or equal to about 0.51 mS/cm. As best shown in FIG. 4, the electrolyte membrane 26 comprises a sulfide-based solid electrolyte 46, a polymer binder 48, an inorganic filler 50, an inorganic lithium salt 52, and an ionic liquid 54.

The sulfide-based solid electrolyte 46 formulated to provide the electrolyte membrane 26 with high ionic conductivity and good interfacial contact with the facing surfaces 42, 44 of the negative and positive electrodes 22, 24. The sulfide-based solid electrolyte 46 is at least partially crystalline and comprises lithium sulfide (Li₂S) and at least one element selected from the group consisting of phosphorus (P), tin (Sn), silicon (Si), germanium (Ge), boron (B), gallium (Ga), and aluminum (Al). In aspects, the sulfide-based solid electrolyte 46 may comprise Li₂S and at least one additional inorganic compound selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), arsenic sulfide (As₂S₅), and manganese sulfide (MnS).

The sulfide-based solid electrolyte 46 may comprise a binary sulfide, a ternary sulfide, a quaternary sulfide, or a combination thereof. In aspects where the sulfide-based solid electrolyte 46 comprises a binary sulfide, the sulfide-based solid electrolyte 46 may comprise lithium sulfide (Li₂S) and at least one additional sulfide selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), and aluminum sulfide (Al₂S₃). For example, the sulfide-based solid electrolyte 46 may comprise a binary sulfide of Li₂S—P₂S₅ (e.g., Li₃PS₄, Li₇P₃S₁₁ and Li_{9.6}P₃S₁₂), Li₂S—SnS₂ (e.g., Li₄SnS₄), Li₂S—SiS₂, Li₂S—GeS₂, Li₂S—B₂S₃, Li₂S—Ga₂S₃, Li₂S—P₂S₃, Li₂S—Al₂S₃, or a combination thereof. In aspects where the sulfide-based solid electrolyte 46 comprises a ternary sulfide, the sulfide-based solid electrolyte 46 may comprise lithium sulfide (Li₂S) and at least two additional inorganic compounds selected from the group consisting of phosphorus sulfide (P₂S₅), tin sulfide (SnS₂), silicon sulfide (SiS₂), germanium sulfide (GeS₂), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), and arsenic sulfide (As₂S₅). For example, the sulfide-based solid electrolyte 46 may comprise a ternary sulfide of Li₂O—Li₂S—P₂S₅, Li₂S—P₂S₅—P₂O₅, Li₂S—P₂S₅—GeS₂ (e.g., Li_{3.25}Ge_{0.25}P_{0.75}S₄ and/or Li₁₀GeP₂S₁₂), Li₂S—P₂S₅—LiX (where X is at least one of F, Cl, Br, and I) (e.g., Li₆PS₅Br, Li₆PS₅Cl, L₇P₂S₈I, and/or Li₄PS₄I), Li₂S—As₂S₅—SnS₂ (e.g., Li_{3.833}Sn_{0.833}As_{0.166}S₄), Li₂S—P₂S₅—Al₂S₃, Li₂S—LiX—SiS₂ (where X is at least one of F, Cl, Br, and I), 0.4LiI·0.6Li₄SnS₄, Li₁₁Si₂PS₁₂, or a combination thereof. In aspects where the sulfide-based solid electrolyte 46 comprises a quaternary sulfide, the sulfide-based solid electrolyte 46 may comprise lithium sulfide (Li₂S) and at least three additional inorganic compounds selected from the group consisting of phosphorus sulfide (P₂S₅), tin sulfide (SnS₂), silicon sulfide (SiS₂), lithium oxide (Li₂O), phosphorus oxide (P₂O₅), lithium chloride (LiCl), lithium iodide (LiI), and manganese sulfide (MnS). For example, the sulfide-based solid electrolyte may comprise a quaternary sulfide of Li₂O—Li₂S—P₂S₅—P₂O₅, Li_{9.54}Si_{1.74}P_{1.44}S_{11.7}Cl_{0.3}, Li₇P_{2.9}Mn_{0.1}S_{10.7}I_{0.3}, Li_{10.35}[Sn_{0.27}Si_{1.08}]P_{1.65}S₁₂, or a combination thereof. In aspects, the sulfide-based solid electrolyte 46 may comprise lithium phosphorus sulfur chloride, Li₆PS₅Cl (LPSCl).

The sulfide-based solid electrolyte 46 may be a particulate material and may comprise particles having a mean particle diameter of greater than or equal to about 1 μm and less than or equal to about 20 μm. The sulfide-based solid electrolyte 46 may constitute, by weight, greater than or equal to about 70%, or optionally greater than or equal to about 90% and less than or equal to about 99%, or optionally less than or equal to about 95% of the electrolyte membrane 26.

The polymer binder 48 is formulated to adhere the components of the electrolyte membrane 26 together and to provide the electrolyte membrane 26 with robust mechanical properties and the ability to exist as a free-standing membrane. The polymer binder 48 may comprise polyethylene oxide (PEO), polyvinylidene difluoride (PVDF), nitrile butadiene rubber (NBR), hydrogenated acrylonitrile butadiene rubber (HNBR), styrene butadiene rubber (SBR), polystyrene-block-poly(ethylene-ran-butylene)-block-polystyrene (SEBS), or a combination thereof. In aspects, the polymer binder 48 comprises polyethylene oxide. The polymer binder 48 may constitute, by weight, greater than or equal to about 3%, or optionally greater than or equal to about 4% and less than or equal to about 20%, or optionally less than or equal to about 9% of the electrolyte membrane 26.

The inorganic filler 50 is formulated to decrease the crystallinity of the polymer binder 48 and increase the ionic conductivity and rate of lithium ion transport through the electrolyte membrane 26. The inorganic filler 50 may comprise aluminum oxide (Al₂O₃), silicon dioxide (SiO₂), or a combination thereof. In aspects, the inorganic filler 50 comprises aluminum oxide. The inorganic filler 50 may be a particulate material and may comprise particles having a mean particle diameter of greater than or equal to about 100 nanometers (nm) and less than or equal to about 10 μm. The inorganic filler 50 may constitute, by weight, greater than or equal to 0%, or optionally greater than or equal to about 0.5% and less than or equal to about 4%, or optionally less than or equal to about 1% of the electrolyte membrane 26.

The inorganic lithium salt 52 is formulated to increase the ionic conductivity of the electrolyte membrane 26, for example, by generating lithium ion transport channels through the polymer binder 48. The inorganic lithium salt 52 may comprise lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethanesulfonyl)imide (LiN(CF₃SO₂)₂), lithium bis(fluorosulfonyl)imide (LiN(FSO₂)₂) (LiFSI), lithium bis(trifluoromethanesulfonyl)azanide (LiTFSA), or a combination thereof. In aspects, the inorganic lithium salt 52 may comprise lithium bis(fluorosulfonyl)imide. The inorganic lithium salt 52 may constitute, by weight, greater than or equal to 0%, or optionally greater than or equal to about 1% and less than or equal to about 3%, or optionally less than or equal to about 2% of the electrolyte membrane 26.

The ionic liquid 54 infiltrates pores defined within the electrolyte membrane 26 by and between the solid components of the electrolyte membrane 26, i.e., the sulfide-based solid electrolyte 46, the polymer binder 48, the inorganic filler 50, and the inorganic lithium salt 52. As shown in FIG. 4, the ionic liquid 54 may be disposed on surfaces of the particles of the sulfide-based solid electrolyte 46 and may entirely encapsulate each of the particles of the sulfide-based solid electrolyte 46. The ionic liquid 54 is formulated to have excellent chemically compatible with the sulfide-based solid electrolyte 46 and to improve the ionic conductivity of the electrolyte membrane 26, for example, by creating lithium ion transfer pathways or “bridges” between the particles of the sulfide-based solid electrolyte 46. The ionic liquid 54 comprises a cation, an anion, and optionally a diluent. The cation and the anion are present in the ionic liquid 54 in substantially equimolar amounts. The ionic liquid 54 may constitute, by weight, greater than or equal to about 1%, or optionally greater than or equal to about 3% and less than or equal to about 20%, or optionally less than or equal to about 7% of the electrolyte membrane 26.

The cation of the ionic liquid 54 may comprise a complex of lithium (Li⁺) and an ethylene glycol dimethyl ether (a glyme), an imidazolium ion, a piperidinium ion, a pyrrolidinium ion, an ammonium ion, a phosphonium ion, or a combination thereof. Examples of glymes include triethylene glycol dimethyl ether (triglyme) and tetraethylene glycol dimethyl ether (tetraglyme). In aspects, the cation of the ionic liquid 54 may comprise a complex of lithium (Li⁺) and triglyme, a complex of lithium (Li⁺) and tetraglyme, or a combination thereof. Examples of imidazolium ions include 1-ethyl-3-methylimidazolium ([Emim]⁺); 1-propyl-3-methylimidazolium ([Pmim]⁺); 1-butyl-3-methylimidazolium ([Bmim]⁺); 1,2-dimethyl-3-butylimidazolium ([DMBim]); 1-alkyl-3-methylimidazolium ([Cnmim]⁺), 1-allyl-3-methylimidazolium ([Amim]⁺); 1,3-diallylimidazolium ([Daim]⁺); 1-allyl-3-vinylimidazolium ([Avim]⁺); 1-vinyl-3-ethylimidazolium ([Veim]⁺); 1-cyanomethyl-3-methylimidazolium ([MCNim]⁺); and 1,3-dicyanomethyl-imidazolium ([BCNim]⁺). Examples of piperidinium ions include 1-propyl-1-methylpiperidinium ([PP₁₃]⁺) and 1-butyl-1-methylpiperidinium ([PP₁₄]⁺). Examples of pyrrolidinium ions include 1-methyl-1-ethylpyrrolidinium ([Pyr₁₂]⁺); 1-propyl-1-methylpyrrolidinium ([Pyr₁₃]⁺); 1-butyl-1-methylpyrrolidinium ([Pyr₁₄]⁺); and methyl-methylcarboxymethyl-pyrrolidinium ([MMMPyr]⁺). Examples of ammonium ions include tetramethylammonium ([N₁₁₁₁]⁺); tetraethylammonium ([N₂₂₂₂]⁺); tributylmethylammonium ([N₄₄₄₁]⁺); diallyldimethylammonium ([DADMA]⁺); N—N-Diethyl-N-methyl-N-(2-methoxyethyl)ammonium ([DEME]⁺); and N,N-diethyl-N-(2-methacryloylethyl)-N-methylammonium ([DEMM]⁺). Examples of phosphonium ions include trimethylisobutyl-phosphonium ([P₁₁₁ᵢ₄]⁺); triisobutylmethylphosphonium ([P₁ᵢ₄₄₄]⁺); tributylmethylphosphonium ([P₁₄₄₄]⁺); diethylmethylisobutyl-phosphonium ([P₁₂₂₄]⁺); and trihexdecylphosphonium ([P₆₆₆₁₀]⁺); trihexyltetradecylphosphonium ([P₆₆₆₁₄]⁺). In aspects, the cation in the ionic liquid 54 comprises a complex of lithium (Li⁺) and tetraglyme.

The anion of the ionic liquid 54 may comprise an arsenate ion, a phosphate ion, a sulfonylimide ion, a borate ion, a chlorate ion, or a combination thereof. An example, of an arsenate ion is hexafluoroarsenate (AsF₆⁻). An example of a phosphate ion is hexafluorophosphate (PF₆⁻). Examples of sulfonylimide ions include bis(fluorosulfonyl)imide (N(FSO₂)²⁻) (FSI), bis(trifluoromethanesulfonyl)imide (N(CF₃SO₂)₂⁻) (TFSI), bis(perfluoroethanesulfonyl)imide (BETI⁻), cyclo-difluoromethane-1,1-bis(sulfonyl)imide (DMSI⁻), and combinations thereof. An example of a chlorate ion is perchlorate (ClO₄⁻). Examples of borate ions include tetrafluoroborate (BF₄⁻), bis(oxalato)borate (B(C₂O₄)₂⁻) (BOB), difluorooxalatoborate (BF₂(C₂O₄)⁻) (DFOB), bis(fluoromalonato)borate (BFMB⁻), and combinations thereof. In aspects, the anion of the ionic liquid 54 comprises bis(trifluoromethanesulfonyl)imide.

The optional diluent may be included in the ionic liquid 54 to decrease the viscosity and improve the lithium ion conductivity of the electrolyte membrane 26. The optional diluent may comprise a nonaqueous aprotic organic solvent. Non-limiting examples of nonaqueous aprotic organic solvents include cyclic carbonates (e.g., ethylene carbonate (EC), propylene carbonate (PC), butylene carbonate (BC), and/or fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, ethyl acetate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane, and/or 1,1,1,2,2-tetrafluoroethyl-2,2,3,3-tetrafluoropropyl ether), cyclic ethers (e.g., tetrahydrofuran, 2-methyltetrahydrofuran), 1,3-dioxolane), acetone, acetonitrile, and toluene.

In aspects, the electrolyte membrane 26 optionally may comprise a halide-based solid electrolyte (not shown), a hydride-based solid electrolyte (not shown), or a combination thereof. Examples of halide-based solid electrolytes include Li₃YCl₆, Li₃InCl₆, Li₃YBr₆, LiI, Li₂CdCl₄, Li₂MgCl₄, Li₂CdI₄, Li₂ZnI₄, and/or Li₃OCl. Examples of hydride-based solid electrolytes include LiBH₄, LiBH₄—LiX (X=Cl, Br or I), LiNH₂, Li₂NH, LiBH₄—LiNH₂, and/or Li₃AlH₆.

The positive electrode 24 is formulated to reversibly store and release lithium ions during discharge and charge of the battery 20 and may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a layered lithium transition metal oxide represented by the formula LiMeO₂, an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt). The electroactive material of the positive electrode 24 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the positive electrode 24.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

In aspects, the positive electrode 24 may further comprise particles of the LiPOS. When included in the positive electrode 24, the LiPOS may constitute, by weight, greater than 0%, optionally greater than or equal to about 10%, or optionally greater than or equal to about 15% and less than or equal to about 30%, or optionally less than or equal to about 20% of the positive electrode 24.

The negative electrode 22 is configured to store and release lithium ions during charge and discharge of the battery 20 and may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive materials for the negative electrode 22 include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22.

In aspects, the electroactive material of the negative electrode 22 may consist of lithium and the negative electrode 22 may be in the form of a nonporous metal film or foil, such as a lithium metal film or lithium metal foil. In other aspects, the negative electrode 22 may be porous and the electroactive material of the negative electrode 22 may be a particulate material. In aspects where the electroactive material of the negative electrode 22 is a particulate material, particles of the electroactive material of the negative electrode 22 may be intermingled with a polymer binder and optionally an electrically conductive material. The same polymer binders and/or electrically conductive materials disclosed above with respect to the positive electrode 24 may be used in the negative electrode 22 in substantially the same amounts.

In aspects, the negative electrode 22 may further comprise particles of the LiPOS. When included in the negative electrode 22, the LiPOS may constitute, by weight, greater than 0%, optionally greater than or equal to about 10%, or optionally greater than or equal to about 15% and less than or equal to about 30%, or optionally less than or equal to about 20% of the negative electrode 22.

The negative and positive electrode current collectors 30, 32 are electrically conductive and provide an electrical connection between the external circuit 36 and their respective negative and positive electrodes 22, 24. In aspects, the negative and positive electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The electrolyte membrane 26 may be manufactured by preparing a precursor mixture comprising the sulfide-based solid electrolyte 46, the polymer binder 48, the inorganic filler 50, the inorganic lithium salt 52, the ionic liquid 54, the optional halide-based solid electrolyte, and the optional hydride-based solid electrolyte, depositing the precursor mixture on a substrate to form a precursor layer, and then removing the solvent from the precursor layer to form the electrolyte membrane 26. The substrate may comprise silica glass, polyethylene terephthalate (PET), polytetrafluoroethylene (PTFE), or a combination thereof. The solvent may comprise a nonaqueous aprotic organic solvent. For example, the solvent may comprise toluene, anisole, benzene, acetonitrile, tetrahydrofuran, heptane, dimethyl carbonate, or a combination thereof. The solvent may constitute, by weight, greater than or equal to about 5% and less than or equal to about 90% of the precursor mixture. The precursor mixture may be deposited on the substrate, for example, via a tape casting technique using a doctor blade. The solvent may be removed from the precursor layer, for example, by drying the precursor layer at a temperature of about 60 degrees Celsius to evaporate the solvent therefrom. After formation of the electrolyte membrane 26, the electrolyte membrane 26 may be removed from the substrate, for example, by peeling the electrolyte membrane 26 off of the substrate. Thereafter, the electrolyte membrane 26 may be assembled into the battery 20.

In aspects, the precursor mixture may be prepared by preparing a solution comprising the polymer binder 48, the inorganic filler 50, and the inorganic lithium salt 52, and then introducing the sulfide-based solid electrolyte 46 and the ionic liquid 54 into the solution. The sulfide-based solid electrolyte 46, the polymer binder 48, the inorganic filler 50, the inorganic lithium salt 52, the ionic liquid 54, the optional halide-based solid electrolyte, and the optional hydride-based solid electrolyte may be mixed together for about 2 hours prior to form the precursor mixture prior to depositing the precursor mixture on the substrate.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. An electrolyte membrane for a battery that cycles lithium ions, the electrolyte membrane comprising:
a sulfide-based solid electrolyte comprising lithium sulfide (Li₂S) and at least one element selected from the group consisting of phosphorus (P), tin (Sn), silicon (Si), germanium (Ge), boron (B), gallium (Ga), and aluminum (Al);
a polymer binder;
an inorganic filler;
an inorganic lithium salt; and
an ionic liquid comprising substantially equimolar amounts of a cation and an anion, the cation comprising a complex of lithium (Li⁺) and an ethylene glycol dimethyl ether, an imidazolium ion, a piperidinium ion, a pyrrolidinium ion, an ammonium ion, a phosphonium ion, or a combination thereof, and the anion comprising an arsenate ion, a phosphate ion, a sulfonylimide ion, a borate ion, a chlorate ion, or a combination thereof.

2. The electrolyte membrane of claim 1, wherein the cation in the ionic liquid comprises a complex of lithium (Li⁺) and triethylene glycol dimethyl ether; a complex of lithium (Li⁺) and tetraethylene glycol dimethyl ether; 1-ethyl-3-methylimidazolium; 1-propyl-3-methylimidazolium; 1-butyl-3-methylimidazolium; 1,2-dimethyl-3-butylimidazolium; 1-alkyl-3-methylimidazolium, 1-allyl-3-methylimidazolium; 1,3-diallylimidazolium; 1-allyl-3-vinylimidazolium; 1-vinyl-3-ethylimidazolium; 1-cyanomethyl-3-methylimidazolium; 1,3-dicyanomethyl-imidazolium; 1-propyl-1-methylpiperidinium; 1-butyl-1-methylpiperidinium; 1-methyl-1-ethylpyrrolidinium; 1-propyl-1-methylpyrrolidinium; 1-butyl-1-methylpyrrolidinium; methyl-methylcarboxymethyl-pyrrolidinium; tetramethylammonium; tetraethylammonium; tributylmethylammonium; diallyldimethylammonium; N—N-diethyl-N-methyl-N-(2-methoxyethyl)ammonium; N,N-diethyl-N-(2-methacryloylethyl)-N-methylammonium; trimethylisobutyl-phosphonium; triisobutylmethylphosphonium; tributylmethylphosphonium; diethylmethylisobutyl-phosphonium; trihexdecylphosphonium; trihexyltetradecylphosphonium; or a combination thereof.

3. The electrolyte membrane of claim 1, wherein the anion in the ionic liquid comprises hexafluoroarsenate, hexafluorophosphate, bis(fluorosulfonyl)imide, bis(trifluoromethanesulfonyl)imide, perchlorate, tetrafluoroborate, cyclo-difluoromethane-1,1-bis(sulfonyl)imide, bis(perfluoroethanesulfonyl)imide, bis(oxalato)borate, difluorooxalatoborate, bis(fluoromalonato)borate, or a combination thereof.

4. The electrolyte membrane of claim 1, wherein the ionic liquid further comprises a diluent selected from the group consisting of dimethyl carbonate, ethylene carbonate, ethyl acetate, acetone, acetonitrile, toluene, propylene carbonate, diethyl carbonate, 1,1,2,2-tetrafluoroethyl-2,2,3,3-tetrafluoropropyl ether, and combinations thereof.

5. The electrolyte membrane of claim 1, wherein the sulfide-based solid electrolyte comprises lithium sulfide (Li₂S) and at least one additional inorganic compound selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), arsenic sulfide (As₂S₅), and manganese sulfide (MnS).

6. The electrolyte membrane of claim 1, wherein the sulfide-based solid electrolyte comprises a binary sulfide comprising lithium sulfide (Li₂S) and at least one additional sulfide selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), and aluminum sulfide (Al₂S₃).

7. The electrolyte membrane of claim 1, wherein the sulfide-based solid electrolyte comprises a ternary sulfide comprising lithium sulfide (Li₂S) and at least two additional inorganic compounds selected from the group consisting of phosphorus sulfide (P₂S₅), tin sulfide (SnS₂), silicon sulfide (SiS₂), germanium sulfide (GeS₂), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), and arsenic sulfide (As₂S₅).

8. The electrolyte membrane of claim 1, wherein the sulfide-based solid electrolyte comprises a quaternary sulfide comprising lithium sulfide (Li₂S) and at least three additional inorganic compounds selected from the group consisting of phosphorus sulfide (P₂S₅), tin sulfide (SnS₂), silicon sulfide (SiS₂), lithium oxide (Li₂O), phosphorus oxide (P₂O₅), lithium chloride (LiCl), lithium iodide (LiI), and manganese sulfide (MnS).

9. The electrolyte membrane of claim 1, wherein the polymer binder comprises polyethylene oxide (PEO), polyvinylidene difluoride (PVDF), nitrile butadiene rubber (NBR), hydrogenated acrylonitrile butadiene rubber (HNBR), styrene butadiene rubber (SBR), polystyrene-block-poly(ethylene-ran-butylene)-block-polystyrene (SEBS), or a combination thereof.

10. The electrolyte membrane of claim 1, wherein the inorganic filler comprises aluminum oxide (Al₂O₃), silicon dioxide (SiO₂), or a combination thereof.

11. The electrolyte membrane of claim 1, wherein the inorganic lithium salt comprises lithium bis(trifluoromethanesulfonyl)imide (LiN(CF₃SO₂)₂), lithium hexafluorophosphate (LiPF₆), lithium bis(fluorosulfonyl)imide (LiN(FSO₂)₂) (LiFSI), or a combination thereof.

12. The electrolyte membrane of claim 1, wherein the sulfide-based solid electrolyte comprises lithium phosphorus sulfur chloride (Li₆PS₅Cl), the polymer binder comprises polyethylene oxide, the inorganic filler comprises aluminum oxide, the inorganic lithium salt comprises lithium bis(fluorosulfonyl)imide, and the ionic liquid comprises substantially equimolar amounts of (i) a complex of lithium (Li⁺) and tetraethylene glycol dimethyl ether and (ii) bis(trifluoromethanesulfonyl)imide.

13. The electrolyte membrane of claim 1, wherein the electrolyte membrane has a thickness of greater than or equal to about 5 micrometers and less than or equal to about 500 micrometers.

14. A battery that cycles lithium ions, the battery comprising:
a negative electrode comprising an electroactive negative electrode material;
a positive electrode spaced apart from the negative electrode and comprising an electroactive positive electrode material; and
an electrolyte membrane disposed between the negative electrode and the positive electrode that provides a medium for the conduction of lithium ions between the negative electrode and the positive electrode, the electrolyte membrane comprising:
a sulfide-based solid electrolyte comprising lithium sulfide (Li₂S) and at least one element selected from the group consisting of phosphorus (P), tin (Sn), silicon (Si), germanium (Ge), boron (B), gallium (Ga), and aluminum (Al);
a polymer binder;
an inorganic filler;
an inorganic lithium salt; and
an ionic liquid comprising substantially equimolar amounts of a cation and an anion, the cation comprising a complex of lithium (Li⁺) and an ethylene glycol dimethyl ether, an imidazolium ion, a piperidinium ion, a pyrrolidinium ion, an ammonium ion, a phosphonium ion, or a combination thereof, and the anion comprising an arsenate ion, a phosphate ion, a sulfonylimide ion, a borate ion, a chlorate ion, or a combination thereof.

15. The battery of claim 14, wherein the cation in the ionic liquid comprises a complex of lithium (Li⁺) and triethylene glycol dimethyl ether; a complex of lithium (Li⁺) and tetraethylene glycol dimethyl ether; 1-ethyl-3-methylimidazolium; 1-propyl-3-methylimidazolium; 1-butyl-3-methylimidazolium; 1,2-dimethyl-3-butylimidazolium; 1-alkyl-3-methylimidazolium, 1-allyl-3-methylimidazolium; 1,3-diallylimidazolium; 1-allyl-3-vinylimidazolium; 1-vinyl-3-ethylimidazolium; 1-cyanomethyl-3-methylimidazolium; 1,3-dicyanomethyl-imidazolium; 1-propyl-1-methylpiperidinium; 1-butyl-1-methylpiperidinium; 1-methyl-1-ethylpyrrolidinium; 1-propyl-1-methylpyrrolidinium; 1-butyl-1-methylpyrrolidinium; methyl-methylcarboxymethyl-pyrrolidinium; tetramethylammonium; tetraethylammonium; tributylmethylammonium; diallyldimethylammonium; N—N-diethyl-N-methyl-N-(2-methoxyethyl)ammonium; N,N-diethyl-N-(2-methacryloylethyl)-N-methylammonium; trimethylisobutyl-phosphonium; triisobutylmethylphosphonium; tributylmethylphosphonium; diethylmethylisobutyl-phosphonium; trihexdecylphosphonium; trihexyltetradecylphosphonium; or a combination thereof, and wherein the anion in the ionic liquid comprises hexafluoroarsenate, hexafluorophosphate, bis(fluorosulfonyl)imide, bis(trifluoromethanesulfonyl)imide, perchlorate, tetrafluoroborate, cyclo-difluoromethane-1,1-bis(sulfonyl)imide, bis(perfluoroethanesulfonyl)imide, bis(oxalato)borate, difluorooxalatoborate, bis(fluoromalonato)borate, or a combination thereof.

16. The battery of claim 14, wherein the sulfide-based solid electrolyte comprises lithium sulfide (Li₂S) and at least one additional inorganic compound selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), arsenic sulfide (As₂S₅), and manganese sulfide (MnS).

17. The battery of claim 14, wherein the polymer binder comprises polyethylene oxide (PEO), polyvinylidene difluoride (PVDF), nitrile butadiene rubber (NBR), hydrogenated acrylonitrile butadiene rubber (HNBR), styrene butadiene rubber (SBR), polystyrene-block-poly(ethylene-ran-butylene)-block-polystyrene (SEBS), or a combination thereof.

18. The battery of claim 14, wherein the inorganic filler comprises aluminum oxide (Al₂O₃), silicon dioxide (SiO₂), or a combination thereof.

19. The battery of claim 14, wherein the inorganic lithium salt comprises lithium bis(trifluoromethanesulfonyl)imide (LiN(CF₃SO₂)₂), lithium hexafluorophosphate (LiPF₆), lithium bis(fluorosulfonyl)imide (LiN(FSO₂)₂) (LiFSI), or a combination thereof.

20. A method of manufacturing an electrolyte membrane for a battery that cycles lithium ions, the method comprising:
(a) preparing a precursor mixture comprising:
a sulfide-based solid electrolyte comprising lithium sulfide (Li₂S) and at least one element selected from the group consisting of phosphorus (P), tin (Sn), silicon (Si), germanium (Ge), boron (B), gallium (Ga), and aluminum (Al);
a polymer binder;
an inorganic filler;
an inorganic lithium salt;
an ionic liquid comprising substantially equimolar amounts of a cation and an anion, the cation comprising a complex of lithium (Li⁺) and an ethylene glycol dimethyl ether, an imidazolium ion, a piperidinium ion, a pyrrolidinium ion, an ammonium ion, a phosphonium ion, or a combination thereof, and the anion comprising an arsenate ion, a phosphate ion, a sulfonylimide ion, a borate ion, a chlorate ion, or a combination thereof; and
a solvent;
(b) depositing the precursor mixture on a substrate to form a precursor layer;
(c) removing the solvent from the precursor layer to form the electrolyte membrane.
